(19) United States
(12) Patent Application Publication
(10) Pub. No.: US 2019/0118880 A1
(43) Pub. Date: Apr. 25, 2019

(54) Drive Tumbler With Replaceable Lugs

(71) Applicant: Boundary Equipment Co. Ltd., Edmonton, Alberta (CA)

(72) Inventors: Alex Tutschek, Edmonton, Alberta (CA); Monte Tutschek, Edmonton, Alberta (CA); Mihai Corabian, Edmonton, Alberta (CA); Dragan Bogojevic, Edmonton, Alberta (CA)

(21) Appl. No.: 16/096,960

(22) PCT Filed: Apr. 12, 2017
(86) PCT No.: PCT/CA2017/050450

§ 371 Date: Oct. 26, 2018

Related U.S. Application Data
(60) Provisional application No. 62/328,919, filed on Apr. 28, 2016.

(51) Int. Cl. B62D 55/13

(52) U.S. Cl. CPC B62D 55/13

(57) ABSTRACT

Disclosed is a drive tumbler or sprocket for driving a continuous track comprising replaceable drive lugs. The drive tumbler comprises a tumbler tire radially extending from the hub cylinder comprising radially extending slots spaced around the tumbler tire. The replaceable lugs are adapted to frictionally engage the sides of the slots and are removably attached in the slots. The lug comprises one or more nubs protruding from the top lug face for engagement with a continuous track and for transferring torque from the drive shaft to the continuous track.

### RELATED APPLICATION

This application claims the benefit of priority of U.S. Patent Application No. 62/328,919 filed Apr. 28, 2016, the entire contents of which is hereby incorporated by reference.

### FIELD OF THE INVENTION

The present invention relates to drive tumblers for continuous tracks, and in particular drive tumblers with replaceable lugs.

### BACKGROUND

In vehicles with continuous tracks, also referred to as crawler tracks or endless tracks, such as mining shovels, tanks, tractors and bulldozers, a drive tumbler transmits rotary force from a drive shaft to the continuous tracks by engaging its teeth, or lugs, with apertures or slots in the track shoes or with track shoe lugs to drive the track.

The tracks and components related thereto of these vehicles encounters substantial wear, even during normal usage due, at least in part, to the abrasive engagement of the lugs with the drive track. As a result, the lugs of the drive tumbler become worn, including wear to the tip and side of the lugs, causing, for example, misalignment and accelerated wear of the other track components. In addition, the lugs of the drive tumbler may encounter other damage, such as scarring, dents, or fractures and corrosive wear from environmental conditions. As a consequence of the considerable weight and size of the drive tumbler, replacement with a newly manufactured drive tumbler can be costly. For a cost efficient alternative, remanufacturing worn drive tumblers is a possibility. In these processes, the damaged material may be cut out and new rings may be welded onto the outside diameter. Alternatively, the drive tumbler may be welded back and shaped to its original dimensions with, for example, weld buildup. However, the drive tumbler must be generally shipped off-site for remanufacturing and the down-time associated with repair results in decreased production and increased cost. Furthermore, heavily remanufactured products may not always perform correctly or as effectively as when new.

Therefore, there is a need for a drive tumbler or components thereof which may be more quickly or easily repaired.

### SUMMARY OF THE INVENTION

In one embodiment, the present invention provides for a drive tumbler for driving a continuous track. The drive tumbler comprises a drive hub base comprising opposing thrust faces and a hub cylinder for mounting on a drive shaft; a tumbler tire radially extending from the hub cylinder comprising radially extending slots spaced around the tumbler tire, each slot defined by generally opposing sloped slot faces and a bottom slot face therebetween, the portion of the tumbler tire between each slot defining a drive flange; and a replaceable drive lug adapted to frictionally engage one of the slots in the tumbler tire and removably attach to the drive hub, the replaceable drive lug comprising generally opposing sloped lug faces for frictionally engaging the opposing sloped slot faces, a top lug face, a bottom lug face and one or more nubs protruding from the top lug face for engagement with a continuous track and for transferring torque from the drive shaft to the continuous track.

In a further embodiment of the drive tumbler outlined above, the lug is engaged in the slot at a radial distance above the bottom slot face.

In a further embodiment of the drive tumbler or drive tumblers outlined above, the radial height is adjustable by an angle of the sloped slot and lug faces.

In a further embodiment of the drive tumbler or drive tumblers outlined above, each slot further comprises a radius transition connecting the sloped slot faces and the bottom slot face.

In a further embodiment of the drive tumbler or drive tumblers outlined above, the opposing slot faces taper towards each other as they approach the bottom slot face.

In a further embodiment of the drive tumbler or drive tumblers outlined above, the opposing sloped lug faces taper towards each other as they approach the bottom lug face at an angle substantially equal to the angle of the taper of the opposing slot faces.

In a further embodiment of the drive tumbler or drive tumblers outlined above, the drive tumbler further comprises intermediate clamping blocks for mounting onto the drive hub base between the lugs.

In a further embodiment of the drive tumbler or drive tumblers outlined above, a base of the drive flanges comprises opposing extensions in the axial direction on both axial sides of the drive flanges.

In a further embodiment of the drive tumbler or drive tumblers outlined above, the drive tumbler comprises intermediate clamping blocks for mounting onto the extensions of the drive flanges between the lugs.

In a further embodiment of the drive tumbler or drive tumblers outlined above, the lug is fastened in the slot to the drive hub base with at least one bolt, the at least one bolt extending through at least one fastening hole in the lug to at least one threaded hole in the drive hub base.

In a further embodiment of the drive tumbler or drive tumblers outlined above, the at least one threaded hole in the drive hub base and the at least one fastening hole at the bottom lug face comprise counterbores for accepting a guide sleeves.

In a further embodiment of the drive tumbler or drive tumblers outlined above, the at least one fastening hole at the top lug face comprises a counterbore for accepting a bolt head, a cover plate, or a combination thereof.

In a further embodiment of the drive tumbler or drive tumblers outlined above, the lug further comprises a lowered middle block section defined by periphery nubs for engaging the track, the nubs extending radially past the lowered middle block section for engaging with the continuous track.

In one embodiment, the present invention provides for a replaceable lug for a drive tumbler for driving a continuous track. The replaceable lug comprises opposing sloped lug faces, a top lug face, a bottom lug face, and one or more nubs protruding from the top lug face for engagement with the continuous track.

The replaceable lug adapted for removable attachment in a slot of the drive tumbler, the opposing sloped lug faces adapted to frictionally engage the slot of the drive tumbler for transferring torque from a drive shaft to the lug via the opposing sloped lug faces and onto the continuous track via the one or more nubs.

In one embodiment, the present invention provides for a method of replacing a replaceable lug on a drive tumbler for driving a continuous track. The method comprises unfastening the replaceable lug from the slot of the drive tumbler adapted to frictionally engage the replaceable lug, and fastening a new replaceable lug to the slot of the drive tumbler.

In a further embodiment of the method outlined above, the method further comprises unfastening an intermediate clamping block from a hub cylinder, and fastening a new intermediate clamping block to the hub cylinder.

### BRIEF DESCRIPTION OF THE DRAWINGS

FIG. 1 is a perspective view illustrative of one embodiment of a drive tumbler with replaceable lugs;

FIG. 2 is a perspective view illustrative of one embodiment of a drive tumbler with replaceable lugs including three lugs, two intermediate clamping blocks in between the lugs, and guide sleeves;

FIG. 3 is a front view illustrative of the embodiment of the drive tumbler of FIG. 1;

FIG. 4 is a perspective view illustrative of the embodiment of the drive tumbler of FIG. 1 depicted without the replaceable lugs, intermediate clamping blocks and guide sleeves;

FIG. 5 is a front view illustrative of the embodiment of the drive tumbler of FIG. 4;

FIG. 6 is a perspective view illustrative of one embodiment of the lug depicted in FIGS. 1 and 2;

FIG. 7 is a perspective view illustrative of one embodiment of a lug;

FIG. 8 is a perspective view illustrative of one embodiment of the guide sleeve depicted in FIGS. 1 and 2;

FIG. 9 is a perspective view illustrative of one embodiment of a cover plate depicted in FIG. 1; and

FIG. 10 is a perspective view illustrative of an embodiment of the intermediate clamping block depicted in FIGS. 1 and 2.

### DETAILED DESCRIPTION

Described herein are embodiments illustrative of drive tumblers and lugs. It will be appreciated that the embodiments and examples described herein are for illustrative purposes intended for those skilled in the art and are not meant to be limiting in any way. All references to embodiments or examples throughout the disclosure should be considered a reference to an illustrative and non-limiting embodiment or an illustrative and non-limiting example.

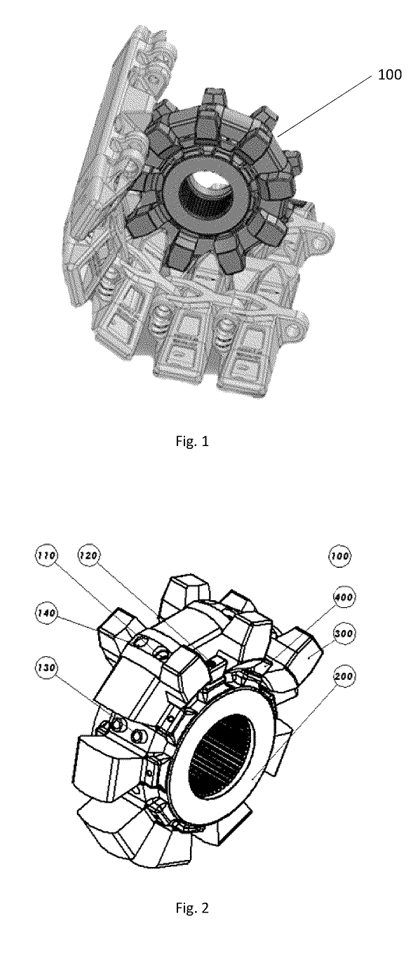

With reference to FIGS. 1 and 2, one embodiment of the present invention provides for a drive tumbler shown generally at 100 for use with a continuous track (not shown). The drive tumbler 100 comprises a drive hub base 200, a tumbler tire 213, and a replaceable drive lug 300.

The drive hub base 200 comprises generally opposing thrust faces 203 and 204 that restrict side movement while in use, and a hub cylinder 201 with a splined bore 202 for receiving a drive shaft. The hub cylinder 201 extends radially into a faceted or round tumbler tire 213 with a width complementing the continuous track with which it is intended to be used. As shown in FIGS. 1-5, the tumbler tire 213 comprises a number of slots 205 spaced around the tumbler tire 213. Each slot 205 radiates outward from the hub cylinder 201 and is defined on its periphery by two generally opposing sloped slot faces 206 and 207, and a bottom slot face 210 therebetween. Drive flanges 218 extend radially outward from the bore 202 and define the solid portion of the tumbler tire 213 between the slots 205. The slots 205 may be equally spaced around the tumbler tire 213 to correspond to equally-spaced track shoes, or may be irregularly spaced in accordance with the spacing of the track shoes.

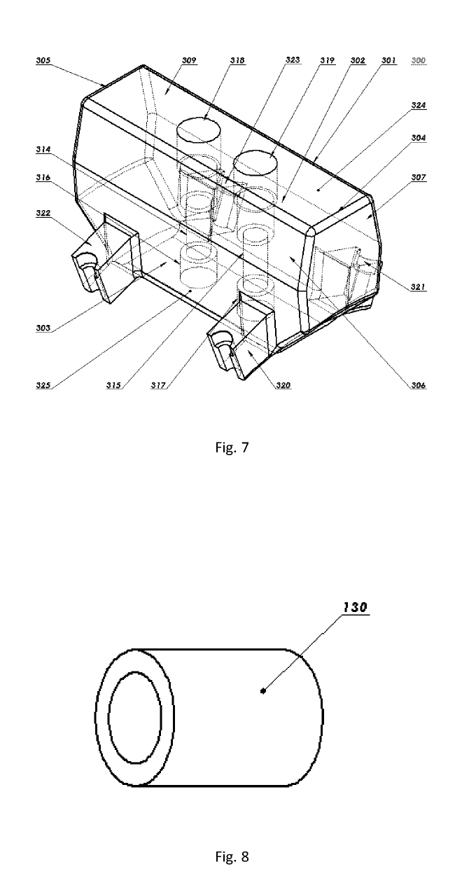

With reference to FIGS. 6 and 7, the replaceable drive lug 300 comprises sloped lug faces 302 and 303, a top lug face 324 and a bottom lug face 325. Each replaceable drive lug is adapted to be received, optionally in a friction fit or friction engaging manner, in the slot 205 where it is fastened to the drive hub base 200, as will be outlined below with reference to FIGS. 6 and 7. The sloped lug faces 302 and 303 may be tapered or angled to correspond to the angle of the sloped slot faces 206 and 207 for a tight fit. If the angle of the sloped lug faces 302 and 303 corresponds to the angle of the sloped slot faces 206 and 207, a greater percentage of the faces will be in contact when the lug 300 is inserted in the slot 205. The sloped faces and the engagement of the sloped lug faces 302 and 303 with the sloped slot faces 206 and 207 allow for the distribution of the load imparted by the drive shaft, ensuring that the forces are approximately equally distributed over the sloped surfaces 206, 207, 302 and 303. In this arrangement, the lugs transfer torque from the drive shaft to the continuous track via the interface between the sloped lug faces 206 and 207 and the sloped slot faces 302 and 303.

One of skill in the art will appreciate that the opposing sloped faces 206, 207, 302 and 303 encompass faces that are sloped with the same angle from a reference line or that are sloped with different angles relative to a reference line. For example, considering the reference line as passing radially outward from the centre of the lug 300 or slot 205, both faces may be angled, for example, 10° from the reference line. Specifically in one example, if the reference line is 0°, the opposing faces may be tapered such that one face is angled 10° from the reference line and the other face is angled −10° from the reference line. Alternatively, one face may be parallel to the reference line while the other opposing face may be angled 10° from the reference line. In the context of the present invention, the sloped faces 206, 207, 302 and 303 may be angled 0 to 40°. The angles will depend on the size of the drive tumbler, the power/torque to be transmitted to the continuous track and the desired ease of removing the lugs 300 from the slots 205, where various angles may lead to a higher difficulty of removing the lugs 300.

With regard to opposing sloped faces 206, 207, 302 and 303, it will also be appreciated that sloped slot faces 206 and 207 can have varying degrees of frictional contact with sloped lug faces 302 and 303. This may be due to the fact that the machined sloped faces will have natural variations from manufacturing and may not be precisely straight and complimentary to each other. However, it is contemplated that the sloped slot faces 206 and 207 sufficiently engage the sloped lug faces 302 and 303 to allow for a relatively close fit wherein the lugs 300 are sufficiently locked, engaged or friction fit into the slots 205 when a radial downward force is applied to the lugs 300.

It will be appreciated that the dimensions, angles and sizes depicted in FIGS. 1 to 10 are for illustrative purposes and will vary according to the requirements of the drive tumbler and the dimensions of the continuous track. For example, in FIGS. 1 to 5, nine slots 205 are depicted; however, the number of slots can be adjusted to complement the size and dimensions of the continuous track and the frequency of apertures or lugs in the continuous track so that appropriate engagement between the lugs 205 and the continuous track is achieved. This includes variations of the width of the slots and their configuration. Furthermore, the size of the tumbler tire 213 comprising the slots 205 may be varied in comparison to the drive hub base 200 according to requirements or as desired.

In a further embodiment, the lug 300 is engaged in the slot 205 at a radial distance above the bottom slot face 210. The radial distance defines a gap and is defined by the distance between the bottom slot face 210 and the bottom lug face 325. This arrangement reduces the stress on the bottom slot face 210, thereby distributing the forces along the sloped slot faces 206 and 207. As the total surface area of the sloped slot faces 206 and 207 is greater than the surface area of the bottom slot face 210, the distributed forces along these sloped faces may result in less wear of the drive tumbler than if the forces were concentrated on the bottom slot face 210. The radial distance may be adjusted by varying the taper or angle of the sloped slot faces 206 and 207 and sloped lug faces 302 and 303, for example, by machining the surfaces. Alternatively, the width of the bottom lug face 325 may be varied. In this regard, a wider bottom lug face 325 results in a smaller radial distance in comparison to a narrower bottom lug face 325. Alternatively or additionally, one or more shims may be placed between the sloped faces 206 and 302, and 207 and 303 to vary the radial distance. The ability to vary the radial distance, especially with the use of shims, allows for quick adjustment to the lug 300 height and the length of the radial distance. This may be useful in certain circumstances where the drive tumbler is required to be transferred to a different vehicle. Alternatively, depending on the type of wear on the drive tumbler 100, the height of the lugs 300 may be adjusted at a time where the lugs have worn, but not to the point of requiring total replacement.

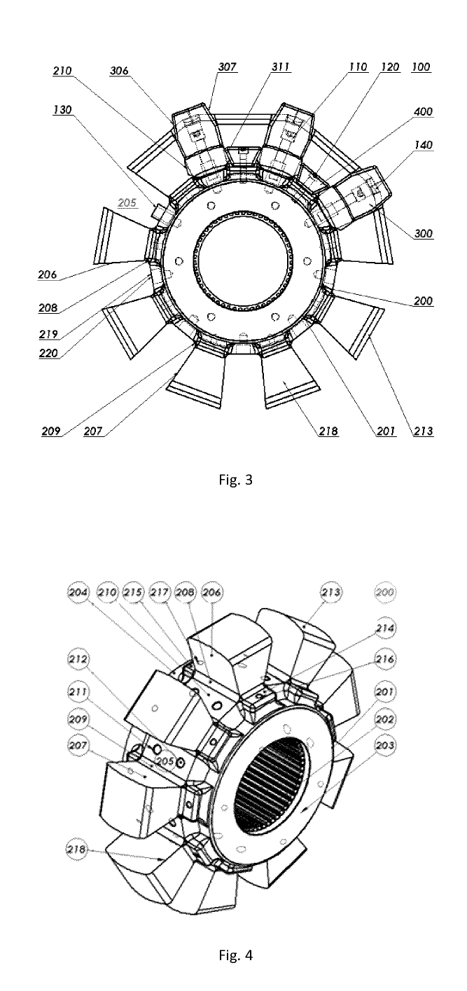

As shown with reference to FIGS. 3 and 4, in one embodiment, the slots may comprise a radius transition 208 and 209 connecting the slot base 210 with the opposing slot sloped faces 206 and 207. The radius transition 208 and 209 may aid in the positioning of the lug at a radial distance from the slot base in that they act to prevent the lug from fully lowering into the slot and contacting the slot base 210. In this regard, the bottom lug face 325 can rest on the radius transition 208 and 209, providing for a gap between the bottom slot face 210 and the bottom lug face 325.

FIG. 6 and FIG. 7 are illustrative representations of different embodiments of the lug 300. The lug dimensions and peripheral configuration will be adapted based on the requirements of the continuous track with which it will be used and may be chosen by the operator or installer. Therefore, these illustrations should not be considered as limiting since various other lug configurations can be utilized in accordance with various continuous track requirements. In both FIGS. 6 and 7, the lugs 300 comprise a block member 301, defined on two sides by the generally opposing sloped lug faces 302 and 303, having a suitable height and width to ensure proper engagement with a track shoe. The embodiment illustrated in FIG. 6 comprises an optionally lowered middle block section 326 defined by two periphery shoe or track engaging nubs 304 and 305 defined by upper section surfaces 306, 307, 308 and 309 protruding from the top lug face 324. In this embodiment, the optionally lowered middle block section 326 has a curved surface, however flat or irregular surfaces are also contemplated. The lower section surfaces 310, 311, 312 and 313 at the lower corners of the lug 300 engage intermediate clamping blocks 400, if present, as will be outlined further below. A uniform surface extending over substantially the entirety of the sloped lug faces 302 or 303 is possible. The nubs 304 and 305 engage the continuous track and therefore the presence of the optionally lowered middle block section 326 results in less material used for manufacture, decreasing the total weight of the drive tumbler. In addition, any fasteners that may extend beyond the lowered middle block section 326 will most likely not interfere with the track. The embodiment illustrated in FIG. 7 comprises one shoe engaging nub 306 protruding from the lug and thereby effectively forming the whole top lug face 324. In addition, this embodiment comprises extended mounting brackets 320, 321, 322 and 323 for fastening the lug 300 to the hub cylinder 201 to provide additional support and to further prevent axial movement of the lug 300. The mounting brackets 320, 321, 322 and 323 may be removably fastened to the hub cylinder with, any suitable means, for example a bolt.

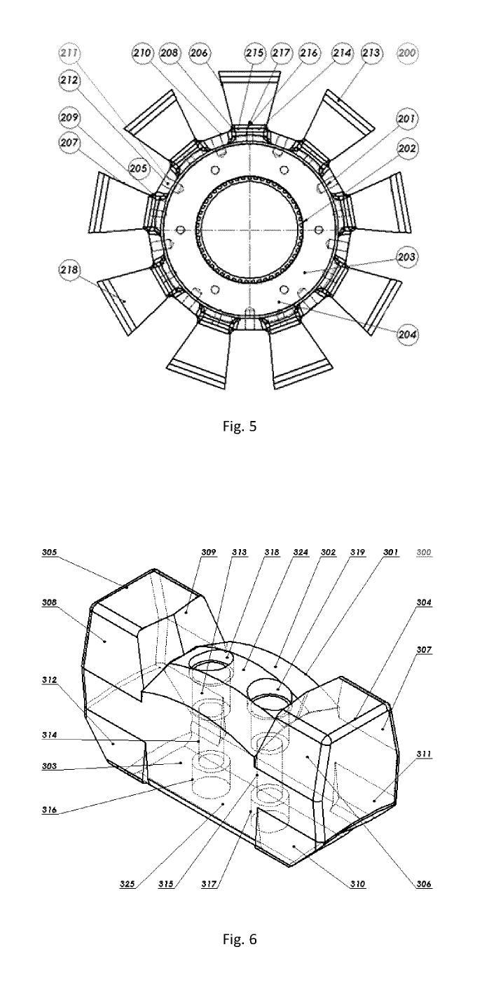

The lug 300 may be fastened in the slot 205 by any suitable means known in the art that provides a secure removable attachment. For example, the lug 300 may be fastened in the slot 205 to the drive hub base 200 with one or more bolt 110 (FIGS. 2 and 3). As depicted in FIGS. 2 and 3, the bolt 110 extends through fastener holes 314 and 315 in the lug 300 to threaded holes 211 and 212 (FIGS. 4 and 5) in the bottom slot face 210 of the drive hub base 200. In these embodiments, two fastener holes 314 and 315 are shown, however an appropriate amount of bolts and corresponding threaded holes may be used in accordance with the size, dimensions and required durability of the drive tumbler 100. In a further embodiment and referring to FIGS. 6 and 7, the fastener holes 314 and 315 comprise lower counterbores 316 and 317 for accepting a guide sleeve 130. The guide sleeve 130 is further accepted by counterbores 219 and 220 (FIG. 3) in the threaded holes 211 and 212 of hub cylinder 201. The guide sleeve 130, along with the bolt 110, aid in preventing axial movement of the drive lug 300. In embodiments where the slope angle between sloped slot faces 206 and 207 is small, the tight engagement of the lug 300 in the slot 205 may cause seizing of the lug 300 in the slot 205. To ensure more facile removal of the lug 300, the fastener holes 314 and 315 may be threaded to allow for the use of an extraction bolt. In this process, the extraction bolt will push down on the guide sleeve 130 and drive the lug 300 radially upwards while the extraction bolt is turned. The use of the guide sleeve 130 prevents damage to the threaded holes 211 and 212 in the slot bottom face 210. The guide sleeve 130 as shown in one embodiment in detail in FIG. 8 comprises a hollow cylinder that is adapted to fit into the lower counterbores 316 and 317 and the counterbores 219 and 220 in the threaded holes 211 and 212.

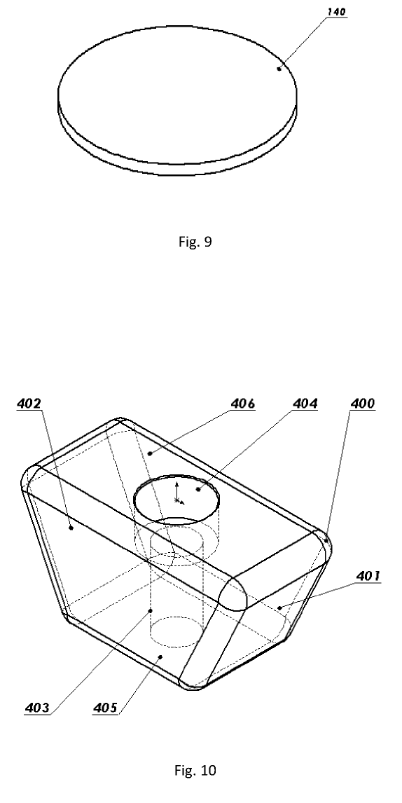

The fastener holes 314 and 315 in the lug 300 may further comprise upper counterbores 318 and 319 for accommodating a bolt head, a cover plate 140 (FIG. 2), or a combination thereof. A depiction of one embodiment of the cover plate 140 is presented in FIG. 9, where the cover plate 140 comprises a disk adapted to fit into the upper counterbores 318 and 219.

In a further embodiment, the drive tumbler 100 further comprises opposing intermediate clamping blocks 400 mounted onto the hub cylinder 201 on either side of each drive flange 218 as shown in FIGS. 2 and 3. It is also contemplated that the base of each drive flange can extended axially on each side of the drive flange to define flange base extensions 214 and 215 as depicted in FIG. 4. In this arrangement, the intermediate clamping blocks 400 may be fastened to the flange base extensions 214 and 215 as shown in FIG. 2, for example with bolts through flange holes 216 and 217. The intermediate clamps 400 are adapted to fit between the lower section surfaces 310, 311, 312 and 313 of the lug 300, providing additional support and aiding to even load distribution. With reference to FIG. 10, an embodiment of the intermediate clamping block 400 is shown and includes two opposing faces 401 and 402 sloped at an angle that corresponds to the angle between two lugs 300 with lug lower faces 310, 311, 312 and 313, a top surface 406 and a bottom surface 405. A fastening hole 403 passes through the block 400 and is positioned in the middle of the intermediate clamping block 400. The fastening hole 403 may comprise a counterbore 404 for accepting a bolt head, a cover plate 140 or a combination thereof. Alternatively, other means for fastening the intermediate clamping block 400 to the drive tumbler, which results in a suitably strong engagement, are contemplated and may be adapted.

The present invention also provides for a replaceable lug for a continuous track drive tumbler. The replaceable lug as outlined herein with reference to FIGS. 6-7, comprises, in one embodiment, opposing sloped lug faces 302 and 303, a top lug face 324, and a bottom lug face 310, and is for fastening in a slot of the drive tumbler. The replaceable lug 300 is adapted to frictionally engage the slot of the drive tumbler as well as the continuous track. The lug 300, when installed in the drive tumbler, transfers torque from the drive shaft to the continuous track.

The present invention also provides for a method of replacing a replaceable lug, such as those described herein, on a continuous track drive tumbler, such as those described herein. Drive tumblers encounter substantial wear in normal usage. Replacing the drive tumbler with a new drive tumbler is a costly procedure and sending the drive tumbler for remanufacturing or even remanufacturing the worn lug on-site results in significant and costly down-time. A drive tumbler with replaceable lugs offers the ability of replacing worn lugs on-site and decreasing down-time. In addition, the replaceable lugs may be manufactured from a material that has enhanced mechanical properties including extended wear life. They may be fastened onto the drive hub base that is made from standard material thereby increasing the durability and quality of the drive tumbler but maintaining costs at a reasonable level. As the lugs made from the enhanced material can be difficult or impossible to machine, they may simply be unfastened from the drive tumbler and replaced with new lugs. In contrast, a drive tumbler made entirely from the enhanced material will be costly and difficult to remanufacture once worn.

The method of replacement depends on how the drive tumblers are fastened. In general, the replaceable lug is unfastened from a slot of the drive tumbler and a new replaceable lug is inserted the slot and fastened to the drive tumbler. In the case where the fastening means are bolts, the blots are removed from each worn lug and the lug is removed from the drive tumbler. The new lug is installed in the slot of the drive tumbler and is fastened to the drive tumbler with bolts. If guide sleeves are used, the guide sleeves may be replaced during the installation or if in good condition, can be re-used. Similarly, depending on the condition of the cover plates, these can be replaced during the installation or can be re-used.

In addition, in an embodiment where intermediate clamping blocks 400 are implemented, they may also wear down and require replacement. The above method may therefore further comprise unfastening the worn intermediate clamping blocks 400 from the hub cylinder and fastening new intermediate clamping blocks to the hub cylinder.

Various embodiments of drive tumblers and replaceable lugs, and methods for replacement of the replaceable lugs have been described. The above-described embodiments are intended to be examples, and alterations and modifications may be effected thereto by those of ordinary skill in the art without departing from the spirit and scope of the teachings.

1. A drive tumbler for driving a continuous track, the drive tumbler comprising:
a drive hub base comprising opposing thrust faces and a hub cylinder for mounting on a drive shaft;
a tumbler tire radially extending from the hub cylinder comprising radially extending slots spaced around the tumbler tire, each slot defined by generally opposing sloped slot faces and a bottom slot face therebetween, the portion of the tumbler tire between each slot defining a drive flange; and
a replaceable drive lug adapted to frictionally engage one of the slots in the tumbler tire and removably attach to the drive hub, the replaceable drive lug comprising generally opposing sloped lug faces for frictionally engaging the opposing sloped slot faces, a top lug face, a bottom lug face and one or more nubs protruding from the top lug face for engagement with a continuous track and for transferring torque from the drive shaft to the continuous track.

2. The drive tumbler of claim 1, wherein the lug is engaged in the slot at a radial distance above the bottom slot face.

3. The drive tumbler of claim 2, wherein the radial height is adjustable by an angle of the sloped slot and lug faces.

4. The drive tumbler of claim 1, wherein each slot further comprises a radius transition connecting the sloped slot faces and the bottom slot face.

5. The drive tumbler of claim 1, wherein the opposing slot faces taper towards each other as they approach the bottom slot face.

6. The drive tumbler of claim 5, wherein the opposing sloped lug faces taper towards each other as they approach the bottom lug face at an angle substantially equal to the angle of the taper of the opposing slot faces.

7. The drive tumbler of claim 1, wherein the drive tumbler further comprises intermediate clamping blocks for mounting onto the drive hub base between the lugs.

8. The drive tumbler of claim 1, wherein a base of the drive flanges comprises opposing extensions in the axial direction on both axial sides of the drive flanges.

9. The drive tumbler of claim 8, wherein the drive tumbler comprises intermediate clamping blocks for mounting onto the extensions of the drive flanges between the lugs.

10. The drive tumbler of claim 1, wherein the lug is fastened in the slot to the drive hub base with at least one bolt, the at least one bolt extending through at least one fastening hole in the lug to at least one threaded hole in the drive hub base.

11. The drive tumbler of claim 10, wherein the at least one threaded hole in the drive hub base and the at least one fastening hole at the bottom lug face comprise counterbores for accepting a guide sleeves.

12. The drive tumbler of claim 10, wherein the at least one fastening hole at the top lug face comprises a counterbore for accepting a bolt head, a cover plate, or a combination thereof.

13. The drive tumbler of claim 1, wherein the lug further comprises a lowered middle block section defined by periphery nubs for engaging the track, the nubs extending radially past the lowered middle block section for engaging with the continuous track.

14. A replaceable lug for a drive tumbler for driving a continuous track, the replaceable lug comprising:
opposing sloped lug faces,
a top lug face,
a bottom lug face, and
one or more nubs protruding from the top lug face for engagement with the continuous track,
the replaceable lug adapted for removable attachment in a slot of the drive tumbler, the opposing sloped lug faces adapted to frictionally engage the slot of the drive tumbler for transferring torque from a drive shaft to the lug via the opposing sloped lug faces and onto the continuous track via the one or more nubs.

15. (canceled)

16. A method of replacing a replaceable lug on a drive tumbler for driving a continuous track, the drive tumbler as defined in claim 1, the method comprising:
unfastening the replaceable lug from the slot of the drive tumbler adapted to frictionally engage the replaceable lug, and
fastening a new replaceable lug to the slot of the drive tumbler.

17. The method of claim 16, wherein the method further comprises:
unfastening an intermediate clamping block from a hub cylinder, and
fastening a new intermediate clamping block to the hub cylinder.

18. The drive tumbler of claim 11, wherein the at least one fastening hole at the top lug face comprises a counterbore for accepting a bolt head, a cover plate, or a combination thereof.
